(19) United States
(12) Patent Application Publication
(10) Pub. No.: US 2016/0356803 A1
(43) Pub. Date: Dec. 8, 2016

(54) CONFIGURABLE ENGINE SPEED INDICATION SYSTEM

(71) Applicant: Caterpillar Inc., Peoria, IL (US)

(72) Inventor: Daniel M. Schnell, Peoria Heights, IL (US)

(73) Assignee: Caterpillar Inc., Peoria, IL (US)

(21) Appl. No.: 15/240,658

(22) Filed: Aug. 18, 2016

(51) Int. Cl. G01P 1/08; B60K 35/00

(52) U.S. Cl. CPC G01P 1/08; B60K 35/00; B60K 2350/1064; B60K 2350/402; B60K 2350/1004

(57) ABSTRACT

A configurable speed indication system for an engine is provided. The configurable speed indication system includes a dial having an arc. The dial also includes an overlay of a plurality of speed limits provided along the arc spaced apart at pre-defined intervals from each other. The dial further includes a first indicator cluster. The first indicator cluster includes a plurality of first light emitting devices. The dial includes a second indicator cluster. The second indicator cluster includes a plurality of second light emitting devices. The configurable speed indication system further includes a control module communicably coupled to the dial. The control module is configured to receive a signal indicative of a type of the engine. The control module is also configured to trigger the activation of each of the sets of the first and second light emitting devices respectively.

### TECHNICAL FIELD

The present disclosure relates to a speed indication system, and more particularly to a configurable system for indicating speed of an engine.

### BACKGROUND

A user interface of a machine generally includes an engine speed indicator to inform an operator of a current speed of an engine mounted on the machine. Machine products typically use a variety of engines which in turn have different requirements for recommended operating thresholds or zones. In some applications, various speed zones are graphically shown on the speed indicator indicating low, medium, and/or high operating speeds of the engine.

As the operating conditions vary based on a type of the engine, a unique printed overlay may be required to indicate the operating conditions for each engine type. Manufacturing of these unique printed overlays having respective part numbers may be difficult to handle from a logistics point of view. Further, the printed overlays may be costly to design and manufacture. In some situations, if an engine associated with the machine is to be replaced with another engine, the existing printed overlay would also have to be replaced with a different printed overlay. This may lead to an undesirable increase in overall operating costs associated with the machine.

U.S. Published Application Number 2004/0104816 describes a tachometer redline display system having separately controllable sections for illuminating one or more of the sections from a removable outside programmable source. The selection of particular ones of the illumination portions allows for construction of a tachometer display device usable with all types of engines. Different redline requirements for different engines are taken into account by the number of illumination portions being turned on in response to the outside programmable source to provide improved efficiency in production and a streamlining of vehicle assembly lines containing tachometers.

### SUMMARY OF THE DISCLOSURE

In one aspect of the present disclosure, a configurable speed indication system for an engine is provided. The configurable speed indication system includes a dial having an arc. The dial also includes an overlay of a plurality of speed limits provided along the arc spaced apart at pre-defined intervals from each other. The dial further includes a first indicator cluster provided on a first side of the arc. The first indicator cluster includes a plurality of first light emitting devices. Each of the plurality of first light emitting devices is configured to emit light of a first color when activated. Further, a set of the activated first light emitting devices is indicative of a first speed zone. The dial includes a second indicator cluster provided on a second side of the arc. The second indicator cluster includes a plurality of second light emitting devices. Each of the plurality of second light emitting devices is configured to emit light of a second color when activated. Further, a set of the activated second light emitting devices is indicative of a second speed zone. The dial further includes a pointer associated with the dial. A position of the pointer is indicative of a current speed of the engine. The configurable speed indication system further includes a control module communicably coupled to the dial. The control module is configured to receive a signal indicative of a type of the engine. The control module is also configured to trigger the activation of each of the sets of the first light emitting devices and the second light emitting devices respectively for configuring the first speed zone and the second speed zone of the dial based on the received signal.

Other features and aspects of this disclosure will be apparent from the following description and the accompanying drawings.

### BRIEF DESCRIPTION OF THE DRAWINGS

FIG. 1 is a schematic view of an exemplary machine having an engine, according to various concepts of the present disclosure;

FIG. 2 is a diagrammatic representation of a dial associated with a configurable speed indication system for the engine of FIG. 1, according to various concepts of the present disclosure;

FIG. 3 is a diagrammatic representation of an exemplary cluster panel associated with the dial of the configurable speed indication system, according to various concepts of the present disclosure;

FIG. 4 is a block diagram of the configurable speed indication system for the engine of FIG. 1, according to various concepts of the present disclosure; and

FIG. 5 is a diagrammatic representation of an exemplary cluster panel associated with the dial associated of the configurable speed indication system, for another type of engine, according to various concepts of the present disclosure.

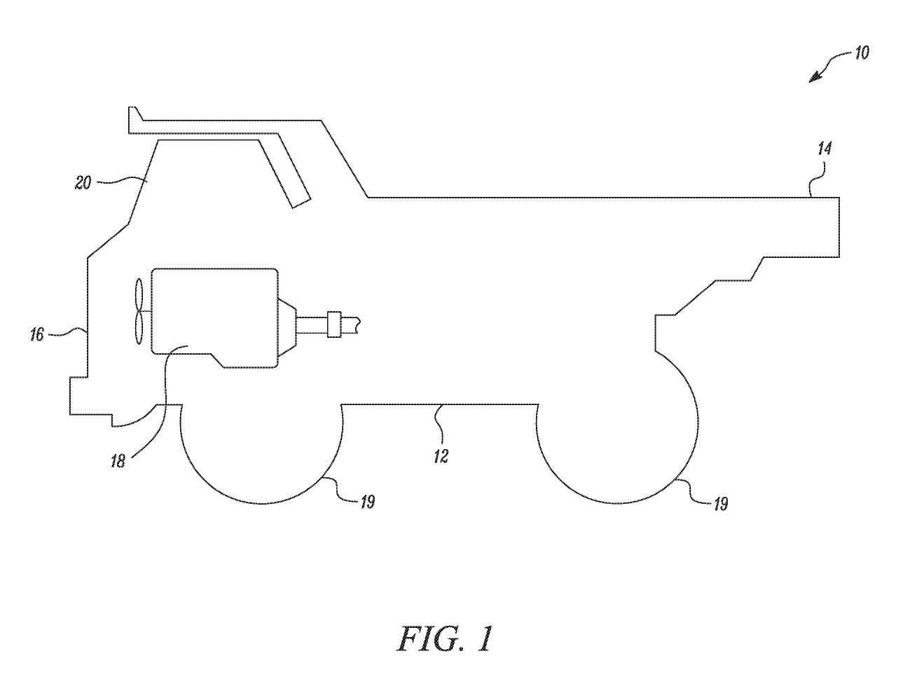

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts. 100091 FIG. 1 illustrates a schematic view of an exemplary machine 10. The machine 10 may perform different tasks on a worksite. For example, the machine 10 may be used to transport material from one location to another on the worksite. The machine 10 may include, but not limited to, a mining truck, a haul truck, an on-highway truck, an off-highway truck, or an articulated truck. Alternatively, the machine 10 may embody a loading machine that unloads payload onto another machine. In such an example, the machine 10 may include, but not limited to, a large wheel loader, a track-type loader, a shovel, or a crane. In one embodiment, the term “machine” used herein may be used to refer to stationary equipment, like a generator, that may be driven by an engine to generate electricity.

As shown in FIG. 1, the machine 10 is a dump truck. However, the concepts of the present disclosure may be embodied in a different type of machine. The machine 10 includes a frame 12. The machine 10 also includes a load carrier 14 for carrying payload. Further, an enclosure 16 may be mounted on the frame 12. An engine 18 is positioned within the enclosure 16. The engine 18 is adapted to combust a fuel to release the chemical energy therein and convert that energy to mechanical power. The engine 18 may be a compression ignition engine that combusts diesel fuel. Alternatively, the engine 18 may include a spark ignition engine that is configured to combust gasoline or other fuels such as ethanol, bio-fuels, or the like.

The machine 10 also includes a powertrain (not shown) supported on the frame 12. The powertrain is drivably connected to the engine 18. The machine 10 also includes a number of wheels 19 embodied as ground engaging members for mobility on ground surfaces.

The machine 10 includes an operator cabin 20 mounted on the frame 12 of the machine 10. An operator of the machine 10 is seated in the operator cabin 20 for operating the machine 10. The operator cabin 20 includes a user interface (not shown). The user interface includes various indicating systems, such as, an engine speed indication system, a machine speed indication system, a fuel level indicator, etc. Further, the user interface also includes various control levers or buttons that allow the operator to operate the machine 10.

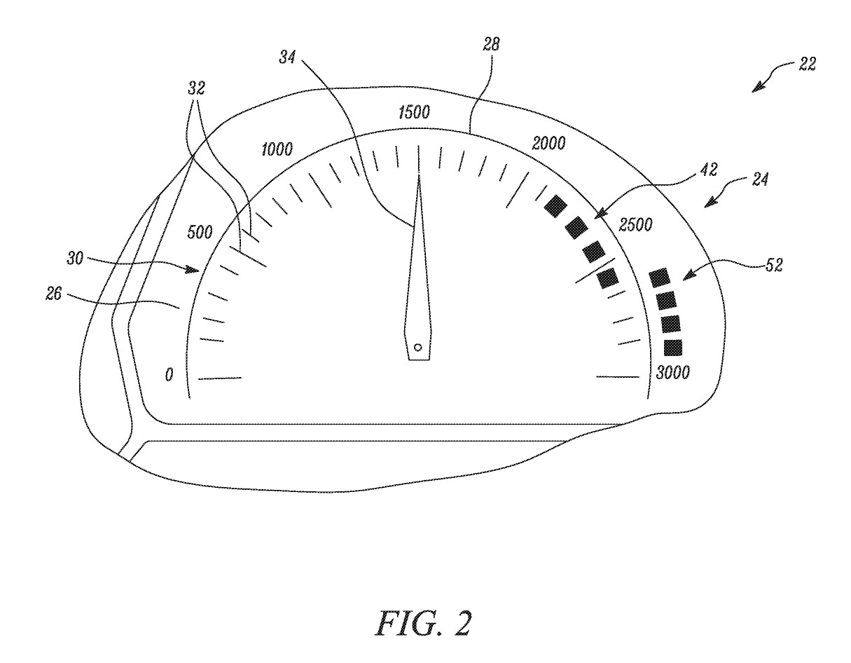

The present disclosure is directed towards a configurable engine speed indication system 22 (See FIG. 2) for indicating the speed of the engine 18. The configurable engine speed indication system 22 will be hereinafter interchangeably referred to as the speed indication system 22. Referring to FIG. 2, the speed indication system 22 includes a dial 24. The dial 24 is semi-circular in shape. Alternatively, the dial 24 can be circular in shape, without any limitations.

The dial 24 includes an overlay 26. The overlay 26 is generally made of a transparent material. In one example, the overlay 26 may be made of a glass or a plastic, without any limitations. The overlay 26 includes a first arc 28 provided on a front or upper facing layer of a two layered dial 24. A number of incremental speed values 30 are provided along the first arc 28 of the overlay 26. The speed values 30 are spaced apart at pre-defined intervals from each other along the first arc 28. In one example, the speed values 30 may be displayed as dashes 32 at increments of 100 Revolutions Per Minute (RPM). Alternatively, the speed values 30 may be displayed as dashes at increments of 10 RPM. In some examples, the dashes 32 are marked with a white translucent ink. Further, numerical values of the speed may also be displayed on the first arc 28 for operator readability. In the illustrated embodiment, the numerical values of the speed are displayed at an interval of 500 RPM. However, the numerical values of the speed may be displayed at a different interval, based on system requirements.

The dial 24 also includes a pointer 34. The pointer 34 is movable along the first arc 28 and is indicative of a current speed of the engine 18. The pointer 34 may have a color that is easily distinguishable from the overlay 26. It should be noted that the pointer 34 is embodied as a standard pointer that operates to indicate the current speed of the engine 18.

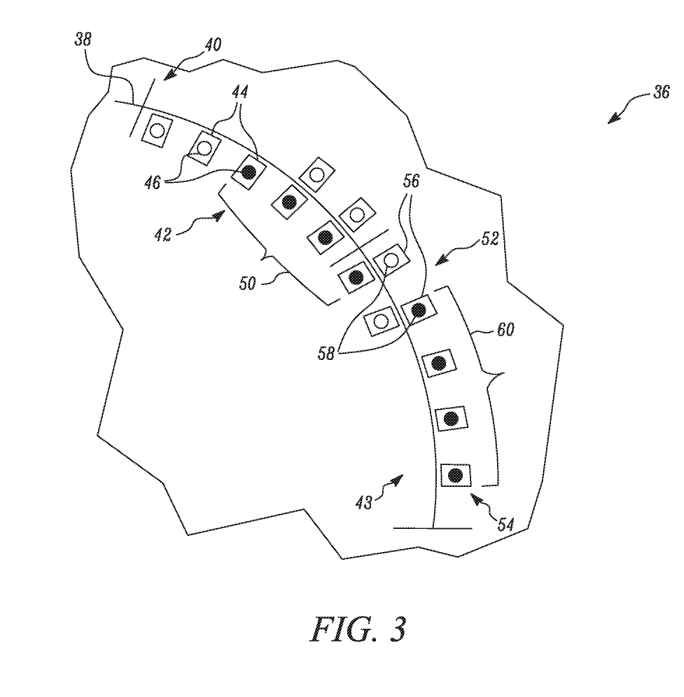

FIG. 3 illustrates a detailed and magnified view of a lower layer of the dial 24 shown in FIG. 2. Referring to FIG. 3, the speed indication system 22 includes a cluster panel 36. In one example, the cluster panel 36 may be embodied as a printed circuit board. The cluster panel 36 includes a second arc 38. The second arc 38 coincides with the first arc 28. A number of speed values 40 are provided along the second arc 38 of the cluster panel 36, corresponding to the speed values 30 provided at pre-defined intervals on the front layer of the dial 24.

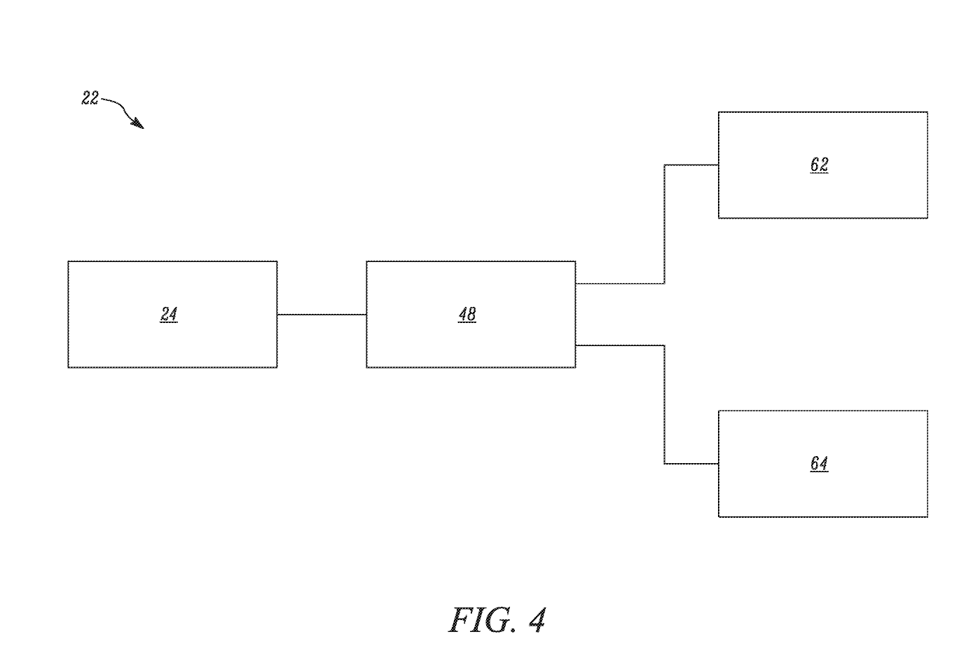

The cluster panel 36 includes a first indicator cluster 42. The first indicator cluster 42 is provided on a first side 43 of the second arc 38. The first indicator cluster 42 includes a number of first locations 44. Further, the first indicator cluster 42 includes a number of first light emitting devices 46. More particularly, each of the first locations 44 of the first indicator cluster 42 includes a first light emitting device 46. Further, each of the first light emitting devices 46 may be individually activated and deactivated, based on signals received from a control module 48 (see FIG. 4). When activated, each of the first light emitting devices 46 emit light of a first color. Further, a set of the activated first light emitting devices 46 is indicative of a first speed zone 50.

The number of the first light emitting devices 46 associated with the cluster panel 36 may vary, based on system requirements. Further, a total number of the activated first light emitting devices 46 associated with the cluster panel 36 may also vary, based on a type of the engine that is associated with the speed indication system 22 and will be explained in detail later in this section. In one example, the first light emitting devices 46 are Light Emitting Diodes (LEDs) that illuminate of a yellow color.

The cluster panel 36 also includes a second indicator cluster 52. The second indicator cluster 52 is provided on a second side 54 of the second arc 38. The second indicator cluster 52 includes a number of second locations 56. Further, the second indicator cluster 52 includes a number of second light emitting devices 58. More particularly, each of the second locations 56 of the second indicator cluster 52 includes a second light emitting device 58. Further, each of the second light emitting devices 58 may be individually activated and deactivated, based on signals received from the control module 48. When activated, each of the second light emitting devices 58 emit light of a second color. Further, a set of the activated second light emitting devices 58 is indicative of a second speed zone 60.

The number of the second light emitting devices 58 associated with the cluster panel 36 may vary, based on system requirements. Further, a total number of the activated second light emitting devices 58 associated with the cluster panel 36 may also vary, based on the type of the engine that is associated with the speed indication system 22. In one example, the second light emitting devices 58 are Light Emitting Diodes (LEDs) that illuminate of a red color.

In some examples, the dial 24 may also include third light emitting devices (not shown) provided at various locations on the dial 24. The third light emitting devices may illuminate of a third color to improve operator readability in dark conditions. In one example, the third light emitting devices are LEDs that emit a warm white color.

It should be further noted that the cluster panel 36 may include more than two indicator clusters 42, 52. For example, the cluster panel 36 may include multiple indicator clusters having various light emitting devices associated therewith. The multiple indicator clusters may have light emitting devices that illuminate of different colors, when activated, in order to indicate different speed zones of the engine 18.

In one example, the cluster panel 36 may include three cluster indicators (not shown). In such an example, the three cluster indicators may include the light emitting devices that emit orange, yellow, and red colors, without any limitations. Thus, the three sets of activated light emitting devices may indicate the three speed zones of the engine 18. In another example, the cluster panel 36 may include four cluster indicators (not shown). In such an example, the four cluster indicators may include the light emitting devices that emit green, orange, yellow, and red colors, without any limitations. Thus, the four sets of activated light emitting devices may indicate the four speed zones of the engine 18. In some examples, the cluster panel 36 may include the light emitting devices provided on both the sides 43, 54 of the second arc 38, such that the number of light emitting devices extend from one end of the second arc 38 to another end, without any limitations.

Referring to FIG. 4, the speed indication system 22 includes the control module 48. The control module 48 is communicably coupled to the dial 24. More particularly, the control module 48 is communicably coupled to the set of the first and second light emitting devices 46, 58. Further, the control module 48 is also communicably coupled to an Electronic Control Unit (ECU) 62 associated with the engine 18 and a Machine Control Unit (MCU) 64 that is present onboard the machine 10. Although the control module 48 is shown to be coupled to the ECU 62 and the MCU 64, in some examples, the control module 48 may be coupled to any one the ECU 62 and the MCU 64. The control module 48 transmits and receives signals from each of the first and second light emitting devices 46, 58, the ECU 62, and the MCU 64.

The control module 48 receives a signal indicative of a type of the engine 18 coupled with the machine 10, from the ECU 62 and/or the MCU 64. Based on the received signal, the control module 48 triggers the activation of the sets of the first light emitting devices 46 and the second light emitting devices 58 respectively, for configuring the first speed zone 50 and the second speed zone 60 of the cluster panel 36.

The number of the first and second light emitting devices 46, 58 that are activated by the control module 48 is based on the type of the engine that is coupled to the machine 10 so that the representation of the first and second speed zones 50, 60 are configured according to the type of the engine. More particularly, the first and second light emitting devices 46, 58 are activated based on the speed zone requirements of the engine 18 that is coupled to the machine 10. Thus, the number of first and second light emitting devices 46, 58 and the respective locations 44, 56 at which the first and second light emitting devices 46, 58 illuminate are configured by the control module 48 based on the type of the engine.

Referring now to FIG. 3, a portion of the cluster panel 36 associated with the engine 18 is shown. The cluster panel 36 is configured as per the type pf the engine 18. As illustrated, four first light emitting devices 46 are activated on the first indicator cluster 42. These first light emitting devices 46 are indicative of the first speed zone 50 of the engine 18. Further, four second light emitting devices 58 are activated on the second indicator cluster 52. These second light emitting devices 58 are indicative of the second speed zone 60 of the engine 18. Further, the control module 48 is also programmed such that the first and second speed zones 50, 60 do not coincide on the dial 24. Referring to FIGS. 2 and 3, the first speed zone 50 lies between speeds of 2000 RPM and 2500 RPM on the dial 24, while the second speed zone 60 lies between 2500 RPM and 3000 RPM on the dial 24.

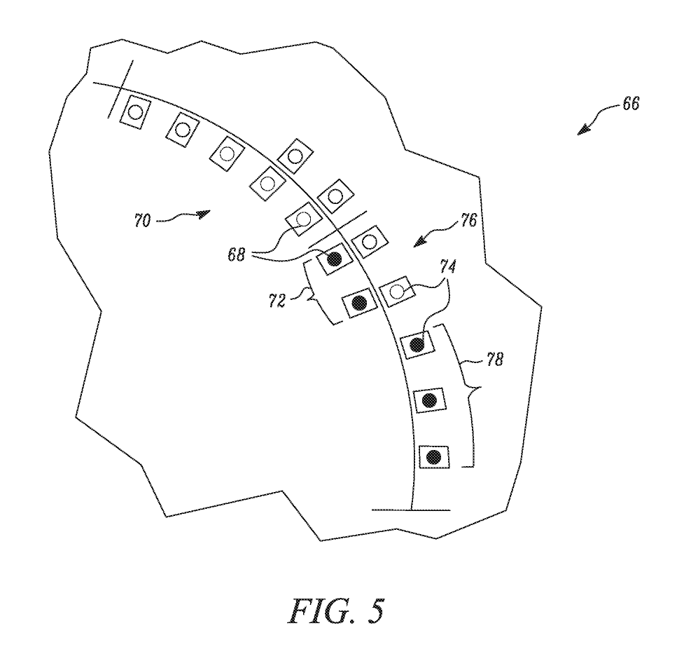

FIG. 5 illustrates a portion of the cluster panel 66 that is configured for another type of the engine. As illustrated, two first light emitting devices 68 are activated on the first indicator cluster 70. These first light emitting devices 68 are indicative of the first speed zone 72 of the engine. Further, three second light emitting devices 74 are activated on the second indicator cluster 76. These second light emitting devices 74 are indicative of the second speed zone 78 of the engine.

It should be noted that the number of the light emitting devices 46, 58, 68, 74 illuminated and the locations at which the first and second light emitting devices 46, 58, 68, 74 illuminate vary in FIGS. 4 and 5, respectively, as the cluster panels 36, 66 are configured for two different types of engine.

The control module 48 may embody a single microprocessor or multiple microprocessors. Numerous commercially available microprocessors can be configured to perform the functions of the control module 48. The control module 48 may include all the components required to run an application such as, for example, a memory, a secondary storage device, and a processor, such as a central processing unit or any other means known in the art. Various other known circuits may be associated with the control module 48, including power supply circuitry, signal-conditioning circuitry, communication circuitry, and other appropriate circuitry.

### INDUSTRIAL APPLICABILITY

The present disclosure relates to the engine speed indication system 22. Depending on the type of the engine associated with the speed indication system 22, the cluster panel 36, 66 of the speed indication system 22 may be configured to indicate the first and second speed zones 50, 60, 72, 78 for the respective engine. Further, the speed indication system 22 may also be configured to indicate more than two speed zones for the respective engine, based on application requirements. Thus, the present disclosure provides a universal speed indication system 22 that can be used for a number of engine types.

The speed indication system 22 eliminates the requirement of unique overlays for each engine type, thus reducing the costs associated with handling multiple overlays. Also, the speed indication system 22 eliminates manufacturing costs associated with the unique overlays. The speed indication system 22 receives the data pertaining to the engine type from the ECU 62 or the MCU 64, and accordingly configures the speed indication system 22. Thus, the requirement of a separate external system for configuring the speed indication system 22 is eliminated.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A configurable speed indication system for an engine, the configurable speed indication system comprising:
a dial having an arc, the dial including an overlay of a plurality of speed limits provided along the arc spaced apart at pre-defined intervals from each other, the dial further including:
a first indicator cluster provided on a first side of the arc, wherein the first indicator cluster includes a plurality of first light emitting devices, each of the plurality of first light emitting devices configured to emit light of a first color when activated, wherein a set of the activated first light emitting devices is indicative of a first speed zone;
a second indicator cluster provided on a second side of the arc, wherein the second indicator cluster includes a plurality of second light emitting devices, each of the plurality of second light emitting devices configured to emit light of a second color when activated, wherein a set of the activated second light emitting devices is indicative of a second speed zone; and
a pointer associated with the dial, wherein a position of the pointer is indicative of a current speed of the engine; and
a control module communicably coupled to the dial, the control module configured to:
receive a signal indicative of a type of the engine; and
trigger the activation of each of the sets of the first light emitting devices and the second light emitting devices respectively for configuring the first speed zone and the second speed zone of the dial based on the received signal.
